(19) United States
(12) Patent Application Publication
(10) Pub. No.: US 2023/0069287 A1
(43) Pub. Date: Mar. 2, 2023

(54) SERVER DEVICE, CONFERENCE ASSISTANCE SYSTEM, CONFERENCE ASSISTANCE METHOD, AND NON-TRANSITORY COMPUTER READABLE STORAGE MEDIUM

(71) Applicant: NEC Corporation, Minato-ku, Tokyo (JP)

(72) Inventors: Shin NORIEDA, Tokyo (JP); Kenta Fukuoka, Tokyo (JP); Masashi Yoneda, Tokyo (JP); Shogo Akasaki, Tokyo (JP)

(73) Assignee: NEC Corporation, Minato-ku, Tokyo (JP)

(21) Appl. No.: 17/797,185

(22) PCT Filed: Feb. 27, 2020
(86) PCT No.: PCT/JP2020/007889

§ 371 Date: Aug. 3, 2022

(51) Int. Cl. H04L 12/18; G10L 15/08

(52) U.S. Cl. CPC H04L 12/1822; G10L 15/08

(57) ABSTRACT

The present invention provides a server device which enables smooth sharing of information in a conference. This server device is provided with a determination unit and an information provision unit. The determination unit analyzes a statement of a participant in a conference, and determines whether or not the statement of the participant matches a predetermined condition. The information provision unit provides predetermined shared information to the participant in the conference if the statement of the participant matches the predetermined condition.

### TECHNICAL FIELD

The present invention relates to a server device, a conference assistance system, a conference assistance method, and a program.

### BACKGROUND ART

Conferences, meetings, and the like in corporate activities and the like are important places for decision making. Various proposals have been made to efficiently hold conferences.

For example, PTL 1 discloses that contents of a conference are capitalized to improve efficiency of conference operation. A conference assistance system disclosed in PTL 1 includes an image recognition unit. The image recognition unit recognizes an image related to each attendance from video data acquired by a video conference apparatus by using an image recognition technique. The system includes a voice recognition unit. The voice recognition unit acquires voice data of each attendance acquired by the video conference apparatus, and compares the voice data with feature information of the voice of each attendance registered in advance. The voice recognition unit specifies a speaker of each statement in the voice data based on the movement information of each attendance. The conference assistance system includes a timeline management unit that outputs, as a timeline, voice data of each of attendees acquired by the voice recognition unit in a time series of statements.

### CITATION LIST

### Patent Literature

[PTL 1] JP 2019-061594 A

### SUMMARY OF INVENTION

### Technical Problem

A conference is not only a place for decision making but also a place for sharing information among participants of the conference. Specifically, there are many conferences that aim to share the latest technology trend, management information, and the like among all participants. For example, information is shared by projecting materials prepared in advance by participants with a projector or distributing printed matters.

However, information sharing as described above causes problems such as waste of time and resources. For example, in a case where materials are projected by a projector, unnecessary time such as time for connecting a personal computer (PC) to the projector and time for switching connection between a PC owned by another participant and the projector is required. Alternatively, in a case where printed matters are distributed, if there are many participants, there is a problem that paper resources are wasted or it takes time to prepare the paper resources.

A principal object of the present invention is to provide a server device, a conference assistance system, a conference assistance method, and a program that contribute to enabling smooth information sharing in a conference.

### Solution to Problem

According to a first aspect of the present invention, there is provided a server device including a determination unit that analyzes a statement of a participant in a conference and determines whether the statement of the participant matches a predetermined condition; and an information provision unit that provides predetermined shared information to the participant in the conference in a case where the statement of the participant matches the predetermined condition.

According to a second aspect of the present invention, there is provided a conference assistance system including a terminal; and a server device, in which the server device includes a determination unit that analyzes a statement of a participant in a conference and determines whether the statement of the participant matches a predetermined condition, and an information provision unit that provides predetermined shared information to the participant in the conference in a case where the statement of the participant matches the predetermined condition.

According to a third aspect of the present invention, there is provided a conference assistance method including, by a server device, analyzing a statement of a participant in a conference and determines whether the statement of the participant matches a predetermined condition; and providing predetermined shared information to the participant in the conference in a case where the statement of the participant matches the predetermined condition.

According to a fourth aspect of the present invention, there is provided a computer readable storage medium storing a program causing a computer mounted on a server device to execute a process of analyzing a statement of a participant in a conference and determines whether the statement of the participant matches a predetermined condition; and a process of providing predetermined shared information to the participant in the conference in a case where the statement of the participant matches the predetermined condition.

### Advantageous Effects of Invention

According to each aspect of the present invention, the server device, the conference assistance system, the conference assistance method, and the program that contribute to enabling smooth information sharing in a conference are provided. The effect of the present invention is not limited to the above description. According to the present invention, other effects may be achieved instead of or in addition to the effects.

### BRIEF DESCRIPTION OF DRAWINGS

FIG. 1 is a diagram for describing an outline of an example embodiment.

FIG. 2 is a diagram illustrating an example of a schematic configuration of a conference assistance system according to a first example embodiment.

FIG. 3 is a diagram for describing connection between a server device and a conference room according to the first example embodiment.

FIG. 4 is a diagram illustrating an example of a processing configuration of the server device according to the first example embodiment.

FIG. 5 is a diagram illustrating an example of a processing configuration of a user registration unit according to the first example embodiment.

FIG. 6 is a diagram for describing an operation of a user information acquisition unit according to the first example embodiment.

FIG. 7 is a diagram illustrating an example of a user database.

FIG. 8 is a diagram for describing an operation of a conference prior information acquisition unit according to the first example embodiment.

FIG. 9 is a diagram illustrating an example of a conference prior information database.

FIG. 10 is a diagram illustrating an example of a participant list.

FIG. 11 is a diagram illustrating an example of a processing configuration of a keyword detection unit according to the first example embodiment.

FIG. 12 is a diagram illustrating an example of a processing configuration of a conference room terminal according to the first example embodiment.

FIG. 13 is a diagram for describing an operation of a shared information output unit according to the first example embodiment.

FIG. 14 is a sequence diagram illustrating an example of an operation of the conference assistance system according to the first example embodiment.

FIG. 15 is a diagram illustrating an example of a hardware configuration of the server device.

FIG. 16 is a diagram illustrating an example of a schematic configuration of a conference assistance system according to a modification example of the present disclosure.

FIG. 17 is a diagram illustrating an example of a schematic configuration of a conference assistance system according to a modification example of the present disclosure.

### EXAMPLE EMBODIMENT

First, an outline of an example embodiment will be described. The reference numerals in the drawings attached to this outline are attached to each element for convenience as an example for assisting understanding, and the description of this outline is not intended to be any limitation. In a case where there is no particular explanation, the block described in each drawing represents not a configuration in the hardware unit but a configuration in the functional unit. Connection lines between blocks in each drawing include both bidirectional and unidirectional lines. A unidirectional arrow schematically indicates a flow of a main signal (data), and does not exclude bidirectionality. In the present specification and the drawings, elements that can be similarly described are denoted by the same reference numerals, and redundant description may be omitted.

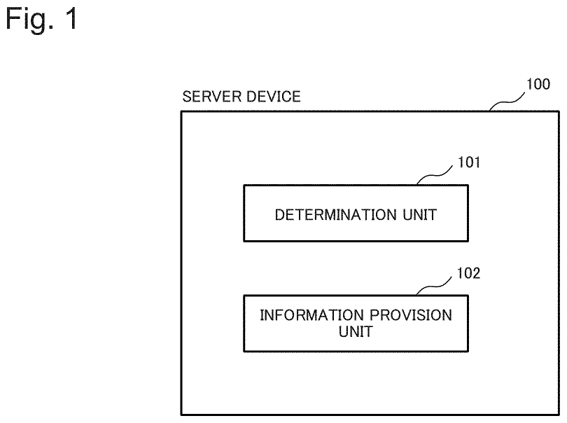

A server device 100 according to one example embodiment includes a determination unit 101 and an information provision unit 102 (refer to FIG. 1). The determination unit 101 analyzes a statement of a participant in a conference, and determines whether the statement of the participant matches a predetermined condition. The information provision unit 102 provides predetermined shared information to the participant in the conference in a case where the statement of the participant matches the predetermined condition.

The server device 100 provides shared information registered in advance to a participant in a case where a statement of the participant participating in a conference matches a predetermined condition. For example, when detecting a predetermined keyword in the statement of the participant participating in the conference, the server device 100 provides the participant in the conference with shared information registered in association with the keyword. As a result, the shared information prepared in advance in conjunction with the statement of the participant is provided to other participants. That is, the server device 100 enables smooth sharing of information in a conference.

Hereinafter, specific example embodiments will be described in more detail with reference to the drawings.

### First Example Embodiment

A first example embodiment will be described in more detail with reference to the drawings.

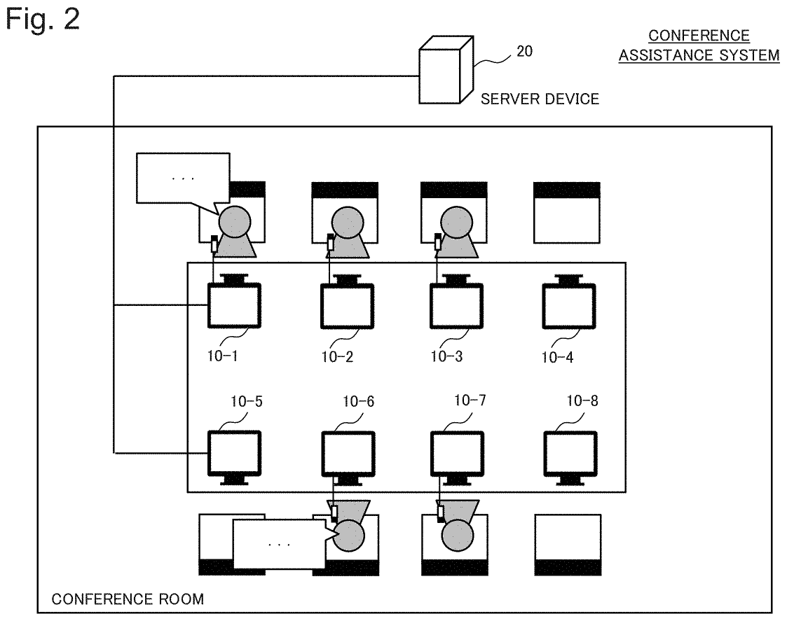

FIG. 2 is a diagram illustrating an example of a schematic configuration of a conference assistance system according to the first example embodiment. Referring to FIG. 2, the conference assistance system includes a plurality of conference room terminals 10-1 to 10-8 and a server device 20. It goes without saying that the configuration illustrated in FIG. 2 is an example and is not intended to limit the number of conference room terminals 10 and the like. In the following description, in a case where there is no particular reason to distinguish the conference room terminals 10-1 to 10-8, they are simply referred to as “conference room terminals 10”.

Each of the plurality of conference room terminals 10 and the server device 20 are connected via wired or wireless communication means, and are configured to be able to communicate with each other. The server device 20 may be installed in the same room or building as the conference room, or may be installed on a network (on a cloud).

The conference room terminal 10 is a terminal installed in each seat of the conference room. The participant operates the terminal to perform the conference while displaying necessary information and the like. The conference room terminal 10 has a camera function and is configured to be able to image a participant who is seated. The conference room terminal 10 is configured to be connectable to a microphone (for example, a pin microphone or a wireless microphone). A voice of a participant seated in front of each of the conference room terminals 10 is collected by the microphone. The microphone connected to the conference room terminal 10 is desirably a microphone with strong directivity. This is because it is only necessary to collect a voice of a user wearing the microphone, and it is not necessary to collect a voice of another person.

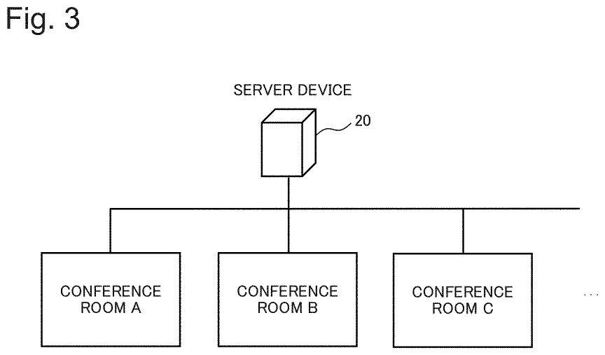

The server device 20 is a device that assists a conference. The server device 20 assists a conference that is a place for decision making and a place for idea generation. Specifically, the server device 20 assists the conference by providing participants with the latest information and the like regarding the topics that are on the agenda together with the progress of the conference. The server device 20 assists a conference held in at least one or more conference rooms as illustrated in FIG. 3.

The server device 20 analyzes a statement of a conference participant and determines whether the statement matches a predetermined condition. In the first example embodiment, the server device 20 determines whether a predetermined keyword (trigger word that will be described later) is included in the statement of the participant.

<Advance Preparation>

Here, in order to enable conference assistance by the server device 20, a system user (a user scheduled to participate in the conference) needs to make an advance preparation. The advance preparation will be described below.

The advance preparation performed by the system user includes two preparations.

A first advance preparation is to register information regarding a user himself/herself in the system.

A second advance preparation is that a participant in the conference inputs information to be presented to participants in the conference (desired to be shared by all the participants) to the server device 20 in advance. Alternatively, the second advance preparation may be interpreted as inputting, to the server device 20, information regarding a topic or the like that is assumed to be an issue to be discussed in the conference before the conference is held.

<First Advance Preparation; System User Registration>

A user registers attribute values such as his/her biological information and profile in the system. Specifically, the user inputs a face image to the server device 20. The user inputs his/her profile (for example, information such as a name, an employee number, a place of employment, a department to which the employee belongs, a position, and a contact information) to the server device 20.

Any method may be used to input information such as the biological information and the profile. For example, the user captures his/her face image by using a terminal such as a smartphone. The user generates a text file or the like in which the profile is written by using the terminal. The user operates the terminal to transmit the information (the face image and the profile) to the server device 20. Alternatively, the user may input necessary information to the server device 20 by using an external storage device such as a Universal Serial Bus (USB) in which the information is stored.

Alternatively, the server device 20 may function as a web server, and the user may input necessary information by using a form provided by the server. Alternatively, a terminal for inputting the information may be installed in each conference room, and the user may input necessary information to the server device 20 from the terminal installed in the conference room.

The server device 20 updates a database that manages system users by using the acquired user information (the biological information, the profiles, and the like). Details regarding update of the database will be described later, but the server device 20 roughly updates the database according to the following operation. In the following description, a database for managing users using the system of the present disclosure will be referred to as a “user database”.

In a case where a person associated to the acquired user information is a new user not registered in the user database, the server device 20 assigns an identifier (ID) to the user. The server device 20 generates feature amount that characterizes the acquired face image.

The server device 20 adds an entry including the ID assigned to the new user, the feature amount generated from the face image, the face image of the user, the profile, and the like to the user database. When the server device 20 registers the user information, a participant in the conference can use the conference assistance system illustrated in FIG. 2.

<Second Advance Preparation; Input of Shared Information>

As described above, the participant inputs, to the server device 20, information that the participant desires to provide to other participants in the conference and that the participant desires to share with other participants. In the following description, information that the participant desires to share with other participants will be referred to as “shared information”. As the shared information, information regarding the latest technology or information regarding management of sales is exemplified.

The participant inputs information for generating a conference ID for specifying a conference in which the participant participates, and information related to the shared information, to the server device 20. Information input by the participant to the server device 20 before the conference is held will be referred to as “conference prior information”. As described above, the conference prior information includes information for generating a conference ID and information related to shared information.

The information related to the shared information includes a keyword related to the shared information and data for specifying the shared information. In the following description, a keyword related to the shared information will be referred to as a “trigger word”. Data for specifying the shared information will be referred to as “shared information specifying data”.

For example, in a case where the participant desires to provide other participants with a web page describing the latest information regarding “AI” (desires to share with other participants), contents of the web page correspond to “shared information”. “AI” is selected as a keyword (trigger word) related to the shared information. The shared information specifying data corresponds to a uniform resource locator (URL) of the web page.

Alternatively, in a case where the participant desires to share a management status with other participants, management information corresponds to the “shared information”. The “sales amount” or the “ordinary profit” is selected as the trigger word. The shared information specifying data corresponds to a path of a storage folder of a file (for example, a file compatible with spreadsheet software) collecting the latest management information.

The participant inputs the conference prior information to the server device 20 according to any method. For example, the participant may input the conference prior information (information serving as a basis of the conference ID and information related to the shared information) to the server device 20 by using his/her terminal, or may input the conference prior information to the server device 20 by using a GUI or the like provided by the server device 20.

<Outline of System Operation>

When the advance preparation by the participants is completed, the conference assistance by the conference assistance system becomes possible. The participant inputs the conference ID (or the information serving as a basis of the conference ID) to the server device 20 at the beginning of the conference. For example, the participant inputs the date and time of the conference or a number of the conference room by using the conference room terminal 10. The server device 20 recognizes the start of the conference when acquiring the conference ID or the information serving as a basis of the conference ID (information for generating the conference ID) from the conference room terminal 10.

When the conference starts, the server device 20 acquires a statement of each participant. The server device 20 determines whether a predetermined keyword (trigger word input in advance) is included in the statement of the participant. When it is determined that the participant has uttered the trigger word, the server device 20 provides the participant in the conference with the shared information associated to the trigger word.

In the above example related to the latest information of “AI”, the server device 20 detects that the participant has uttered the word “AI”, and provides each participant with the contents of the web page at the registered URL.

The participant can perform discussion and the like while referring to the displayed web page. As a result, the information (shared information) prepared in advance by the participants is promptly provided to all the participants, and the efficiency of the conference or the deepening of the discussion can be achieved.

Next, details of each device included in the conference assistance system according to the first example embodiment will be described.

[Server Device]

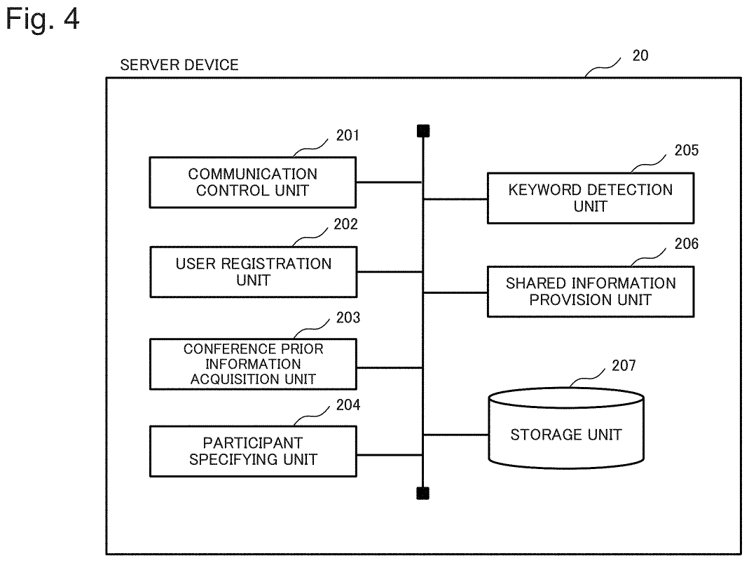

FIG. 4 is a diagram illustrating an example of a processing configuration (processing module) of the server device 20 according to the first example embodiment. Referring to FIG. 4, the server device 20 includes a communication control unit 201, a user registration unit 202, a conference prior information acquisition unit 203, a participant specifying unit 204, a keyword detection unit 205, a shared information provision unit 206, and a storage unit 207.

The communication control unit 201 is a unit that controls communication with other devices. Specifically, the communication control unit 201 receives data (packet) from the conference room terminal 10. The communication control unit 201 transmits data to the conference room terminal 10. The communication control unit 201 delivers data received from another device to another processing module. The communication control unit 201 transmits data acquired from the another processing module to the another device. As described above, the another processing module transmits and receives data to and from the another device via the communication control unit 201.

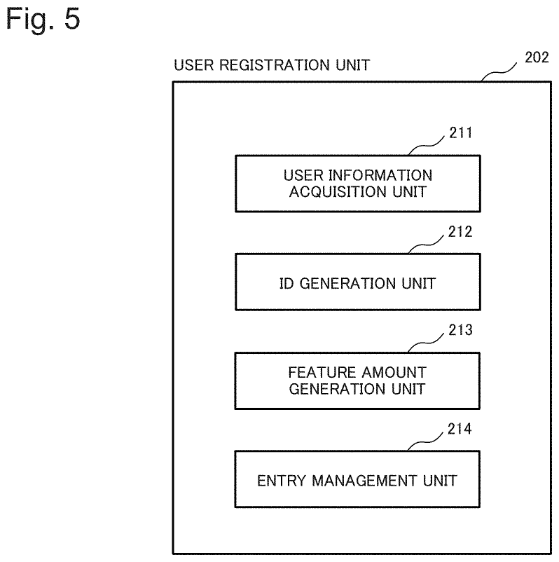

The user registration unit 202 is a unit that enables the system user registration described above. The user registration unit 202 includes a plurality of submodules. FIG. 5 is a diagram illustrating an example of a processing configuration of the user registration unit 202. Referring to FIG. 5, the user registration unit 202 includes a user information acquisition unit 211, an ID generation unit 212, a feature amount generation unit 213, and an entry management unit 214.

The user information acquisition unit 211 is a unit that acquires the user information described above. The user information acquisition unit 211 acquires biological information (face image) and a profile (a name, an affiliation, and the like) of the system user. The system user may input the information from his/her terminal to the server device 20, or may directly operate the server device 20 to input the information.

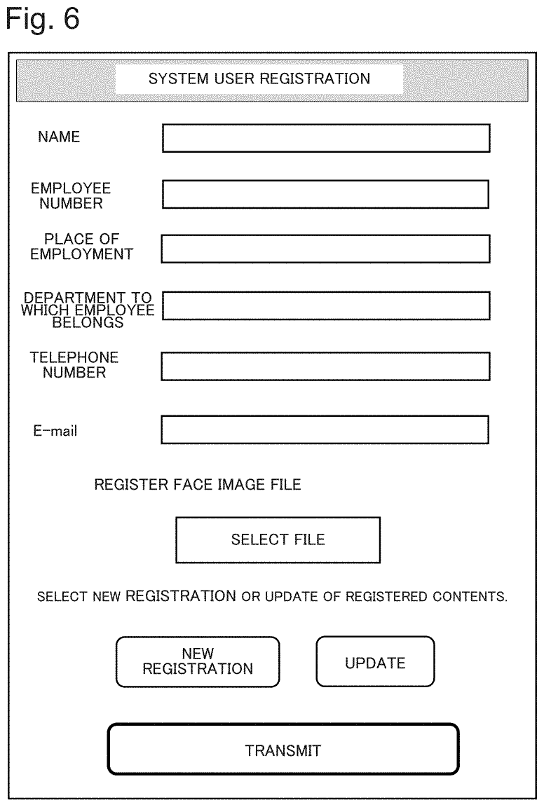

For example, the user information acquisition unit 211 may acquire the above information (the face image and the profile) via a network. Alternatively, the user information acquisition unit 211 may provide a graphical user interface (GUI) or a form for inputting the above information. For example, the user information acquisition unit 211 displays an information input form as illustrated in FIG. 6 on the terminal operated by the user.

The system user inputs the information illustrated in FIG. 6. The system user selects whether to newly register the user in the system or to update the already registered information. After inputting all the information, the system user presses a “transmit” button, and inputs the biological information and the profile to the server device 20.

The user information acquisition unit 211 stores the acquired user information in the storage unit 207.

The ID generation unit 212 is a unit that generates an ID to be assigned to the system user. In a case where the user information input by the system user is information related to new registration, the ID generation unit 212 generates an ID for identifying the new user. For example, the ID generation unit 212 may calculate a hash value of the acquired user information (the face image and the profile) and use the hash value as an ID to be assigned to the user. Alternatively, the ID generation unit 212 may assign a unique value each time user registration is performed and use the assigned value as an ID. In the following description, an ID (an ID for identifying a system user) generated by the ID generation unit 212 will be referred to as a “user ID”.

The feature amount generation unit 213 is a unit that generates feature amount (a feature vector including a plurality of feature amounts) characterizing the face image from the face image included in the user information. Specifically, the feature amount generation unit 213 extracts feature points from the acquired face image. An existing technique may be used for the feature point extraction process, and thus a detailed description thereof will be omitted. For example, the feature amount generation unit 213 extracts eyes, a nose, a mouth, and the like as feature points from the face image. Thereafter, the feature amount generation unit 213 calculates a position of each feature point or a distance between the feature points as a feature amount, and generates a feature vector (vector information characterizing the face image) including a plurality of feature amounts.

The entry management unit 214 is a unit that manages an entry of the user database. When registering a new user in the database, the entry management unit 214 adds an entry including the user ID generated by the ID generation unit 212, the feature amount generated by the feature amount generation unit 213, the face image, and the profile acquired from the user to the user database.

When updating the information regarding the user already registered in the user database, the entry management unit 214 specifies an entry to be subjected to information update based on an employee number or the like, and updates the user database by using the acquired user information. In this case, the entry management unit 214 may update a difference between the acquired user information and the information registered in the database, or may overwrite each item of the database with the acquired user information. Similarly, regarding the feature amount, the entry management unit 214 may update the database when there is a difference in the generated feature amount, or may overwrite the existing feature amount with the newly generated feature amount.

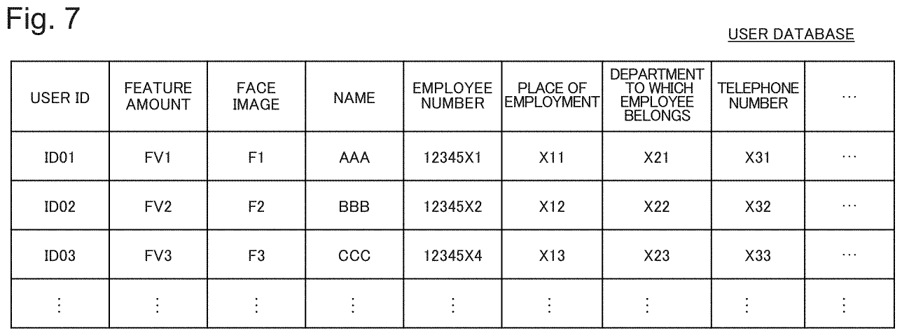

The user registration unit 202 operates to construct a user database as illustrated in FIG. 7. It goes without saying that contents registered in the user database illustrated in FIG. 7 are an example and are not intended to limit information registered in the user database. For example, the “face image” does not have to be registered in the user database as necessary.

FIG. 4 will be referred to again. The conference prior information acquisition unit 203 is a unit that acquires “conference prior information” from participants before the conference is held. The conference prior information acquisition unit 203 acquires conference prior information from a system user (a user scheduled to participate in the conference to be held in the future). For example, the user may input the conference prior information to the server device 20 from his/her terminal, or may directly operate the server device 20 to input the information.

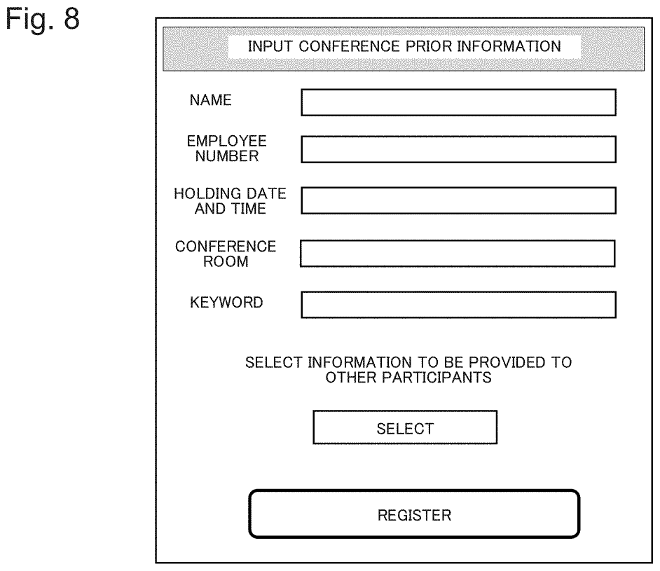

The conference prior information acquisition unit 203 may provide a graphical user interface (GUI) or a form for inputting the conference prior information. For example, the conference prior information acquisition unit 203 displays an information input form as illustrated in FIG. 8 on a terminal operated by the user.

The user inputs the information illustrated in FIG. 8. When the input of the information as illustrated in FIG. 8 is completed, the user presses a “register” button. In response to the pressing of the button, the server device 20 acquires the conference prior information. The keyword illustrated in FIG. 8 corresponds to a “trigger word”. Information specified by a “select” button illustrated in FIG. 8 corresponds to “shared information specifying data”. For example, when the “select” button is pressed, a GUI for selecting the shared information is activated, and the “shared information specifying data” is specified through the user's selection.

The conference prior information acquisition unit 203 generates a conference ID from the acquired conference prior information (information for generating a conference ID included in the conference prior information). For example, the conference prior information acquisition unit 203 generates a combination of the conference date and time and a conference room (conference room number) as a conference ID. Alternatively, the conference prior information acquisition unit 203 may connect the date and time to the information regarding the conference room, and generate a hash value of the connected information as a conference ID. Alternatively, the conference prior information acquisition unit 203 may assign a unique value each time the conference prior information is registered to use the value as a conference ID.

The conference prior information acquisition unit 203 distributes the generated conference ID to the participants of the conference. In a case where the conference ID is generated from the date and time of holding the conference and the conference room number, it is not necessary for the participant to know the conference ID, and thus it is not necessary to distribute the conference ID to the participant.

The conference prior information acquisition unit 203 manages the conference ID, the trigger word, and the shared information specifying data in association with each other. Specifically, the conference prior information acquisition unit 203 adds an entry having the above information to a database (hereinafter, referred to as a conference prior information database) that manages the conference prior information, or updates the corresponding entry.

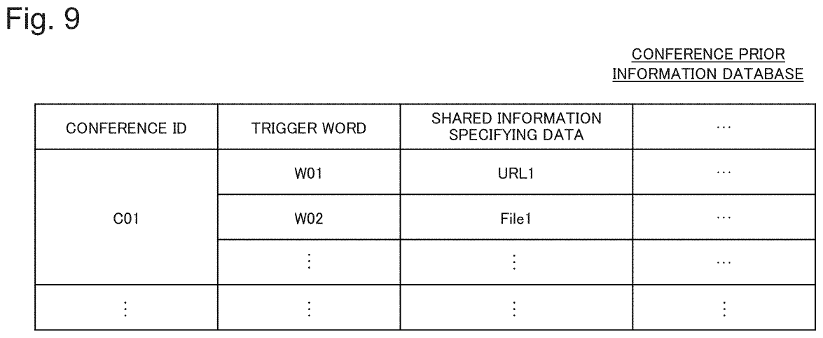

The conference prior information acquisition unit 203 constructs a database as illustrated in FIG. 9 based on the conference prior information acquired from the user. Referring to FIG. 9, a trigger word and information (shared information specifying data) for specifying shared information provided when the trigger word is detected are managed in association with each other for each conference (for each conference ID) held.

The conference prior information database illustrated in FIG. 9 is an example and is not intended to limit the contents thereof. For example, a registrant of the conference prior information may also be stored in the database. In this case, the conference prior information acquisition unit 203 searches the user database by using the name, the employee number, and the like input by the participant, and specifies a user ID associated to the participant. The conference prior information acquisition unit 203 registers the specified user ID in the conference prior information database.

FIG. 4 will be referred to again. The participant specifying unit 204 is a unit that specifies a participant participating in the conference (a user who has entered the conference room among users registered in the system). The participant specifying unit 204 acquires a face image from the conference room terminal 10 in front of a seat of the participant among the conference room terminals 10 installed in the conference room. The participant specifying unit 204 calculates a feature amount from the acquired face image.

The participant specifying unit 204 sets a feature amount calculated based on the face image acquired from the conference room terminal 10 as a collation target, and performs a collation process with a feature amount registered in the user database. More specifically, the participant specifying unit 204 sets the calculated feature amount (feature vector) as a collation target, and executes one-to-N(where N is a positive integer, and the same applies hereinafter) collation with a plurality of feature vectors registered in the user database.

The participant specifying unit 204 calculates a similarity between the feature amount that is a collation target and each of the plurality of feature amounts on the registration side. A chi-square distance, a Euclidean distance, or the like may be used as the similarity. The similarity is lower as the distance is longer, and the similarity is higher as the distance is shorter.

The participant specifying unit 204 specifies a feature amount having a similarity with the feature amount that is a collation target equal to or more than a predetermined value and having the highest similarity among the plurality of feature amounts registered in the user database.

The participant specifying unit 204 reads the user ID associated to the feature amount obtained as a result of the one-to-N collation from the user database.

The participant specifying unit 204 repeatedly performs the above process on a face image acquired from each of the conference room terminals 10, and specifies a user ID associated to each face image. The participant specifying unit 204 generates a participant list by associating the specified user ID with the ID of the conference room terminal 10 that is a transmission source of the face image. As the ID of the conference room terminal 10, a Media Access Control (MAC) address or an Internet Protocol (IP) address of the conference room terminal 10 may be used.

The participant specifying unit 204 acquires a conference ID (or information serving as a basis of the conference ID) from the conference room terminal 10. In a case where the information serving as a basis of the conference ID is acquired, the participant specifying unit 204 generates the conference ID according to the same method as in the conference prior information acquisition unit 203. The participant specifying unit 204 associates the conference ID with the participant list. The participant specifying unit 204 associates the conference ID with the participant list including the conference room terminal ID that is a transmission source of the conference ID (or information serving as a basis of the conference ID).

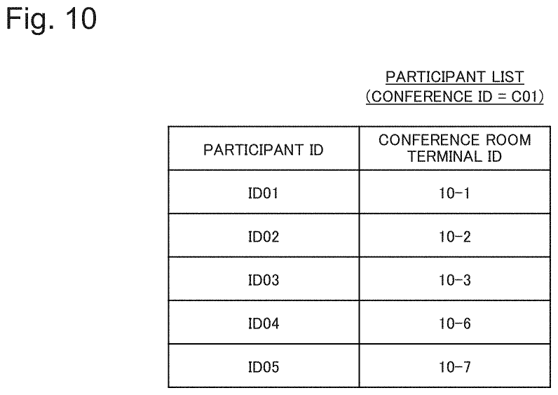

For example, in the example in FIG. 2, a participant list as illustrated in FIG. 10 is generated. In FIG. 10, for better understanding, reference numerals assigned to the conference room terminals 10 are described as conference room terminal IDs. The “participant ID” included in the participant list is a user ID registered in the user database.

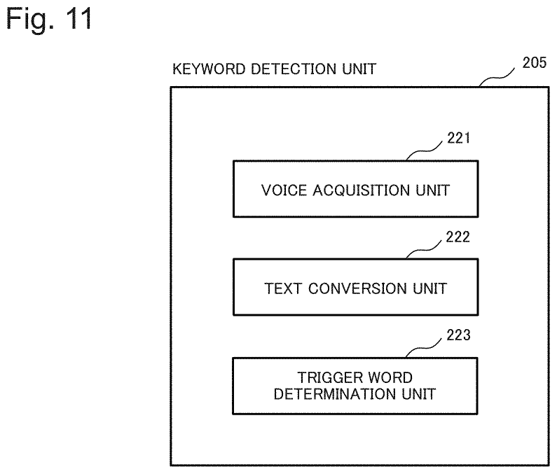

The keyword detection unit 205 is a unit that detects a trigger word from a statement of the participant. The keyword detection unit 205 includes a plurality of submodules. FIG. 11 is a diagram illustrating an example of a processing configuration of the keyword detection unit 205. Referring to FIG. 11, the keyword detection unit 205 includes a voice acquisition unit 221, a text conversion unit 222, and a trigger word determination unit 223.

The voice acquisition unit 221 is a unit that acquires a voice of a participant from the conference room terminal 10. The conference room terminal 10 generates an audio file each time a participant makes a statement, and transmits the audio file to the server device 20 together with an ID (conference room terminal ID) of the own device. The voice acquisition unit 221 delivers the audio file and the conference room terminal ID acquired from the conference room terminal 10 to the text conversion unit 222.

The text conversion unit 222 converts the acquired audio file into text. The text conversion unit 222 converts the contents recorded in the audio file into text by using a voice recognition technique. Since the text conversion unit 222 can use an existing voice recognition technique, detailed description thereof is omitted, but the text conversion unit operates as follows.

The text conversion unit 222 performs filter processing for removing noise and the like from the audio file. Next, the text conversion unit 222 specifies phonemes from sound waves of the audio file. A phoneme is the smallest constituent unit of a language. The text conversion unit 222 specifies a sequence of phonemes and converts the sequence into a word. The text conversion unit 222 creates a sentence from a sequence of words and outputs a text file. At the time of the filter processing, since a voice less than a predetermined level is deleted, even when neighboring sound is included in the audio file, the text file is not generated from the neighboring sound.

The text conversion unit 222 delivers the text file and the conference room terminal ID to the trigger word determination unit 223.

The trigger word determination unit 223 is a unit that determines whether the trigger word stored in the conference prior information database is included in the text file generated from the statements of the participant. The trigger word determination unit 223 refers to the participant list and specifies a conference ID being held. Specifically, the trigger word determination unit 223 specifies a conference ID from the conference room terminal ID of the conference room terminal 10 that has transmitted the voice. For example, in the example in FIG. 10, in a case where a voice is acquired from the conference room terminal 10-1, the conference ID is specified as C01.

The trigger word determination unit 223 determines whether the keyword registered in the trigger word field of the entry associated to the conference being held (the conference having the conference ID input at the beginning of the conference) is included in the acquired text file.

For example, a case is considered in which a participant makes a statement that “AI is becoming more and more important technique”. In this case, when a keyword such as “AI” is registered in the conference prior information database, the trigger word determination unit 223 sets a determination result to “trigger word detected”.

In a case where the trigger word is detected in the statement of the participant, the keyword detection unit 205 reads shared information specifying data associated to the detected trigger word from the conference prior information database. The keyword detection unit 205 notifies the shared information provision unit 206 of the read shared information specifying data and the specified conference ID. The keyword detection unit 205 does not perform a particular operation in a case where the trigger word cannot be detected in the statement.

The shared information provision unit 206 is a unit that provides shared information to participants in the conference. The shared information provision unit 206 provides shared information to each participant based on the shared information specifying data acquired from the keyword detection unit 205.

Specifically, the shared information provision unit 206 acquires shared information specified by the shared information specifying data, and transmits the acquired shared information to the conference room terminal 10. In the above example, the shared information provision unit 206 accesses a URL written in the shared information specifying data and acquires a Hyper Text Markup Language (HTML) file.

Alternatively, the shared information provision unit 206 acquires a file from a folder indicated by the shared information specifying data.

The shared information provision unit 206 transmits the acquired shared information to the conference room terminal 10. More specifically, the shared information provision unit 206 transmits the shared information to the conference room terminal 10 used by each participant. More specifically, the shared information provision unit 206 transmits data (shared information output data) for the conference room terminal 10 outputting the shared information to the conference room terminal 10. Specifically, the shared information provision unit 206 refers to the participant list associated to the conference ID acquired from the keyword detection unit 205, and transmits the shared information to the conference room terminal 10 written in the participant list. That is, the shared information provision unit 206 provides shared information to the participants of the conference associated to the conference ID.

The shared information provision unit 206 does not have to repeatedly transmit the same shared information to the conference room terminal 10. Specifically, the shared information provision unit 206 does not have to repeatedly transmit shared information associated to a trigger word already detected to the conference room terminal 10. Alternatively, in a case where a plurality of pieces of shared information specifying data is registered in the same trigger word, the shared information provision unit 206 may transmit different shared information to the conference room terminal 10 each time a trigger word is detected.

The shared information provision unit 206 may change a form of information provision according to a format of the shared information specifying data. For example, in a case where a URL is registered, the shared information provision unit 206 may transmit the registered URL to the conference room terminal 10 without any change. On the other hand, in a case where a file storage location is registered, the shared information provision unit 206 may access the file storage location to acquire a file, and transmit the acquired file to the conference room terminal 10.

The storage unit 207 is a unit that stores information necessary for an operation of the server device 20.

[Conference Room Terminal]

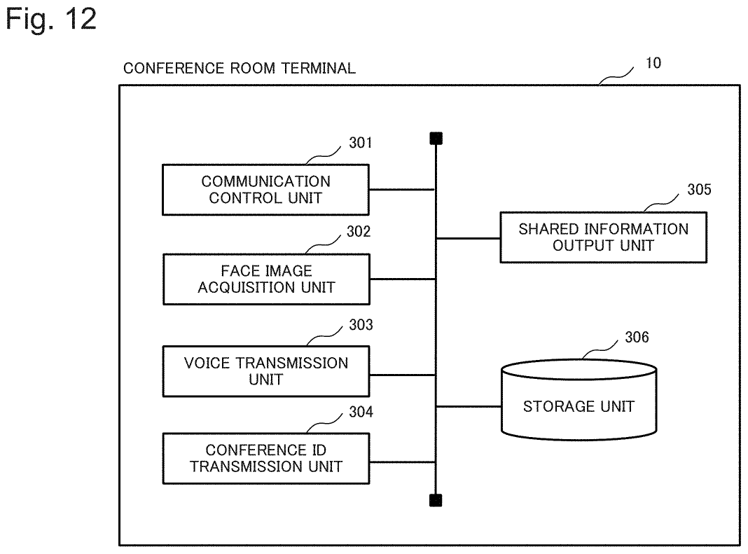

FIG. 12 is a diagram illustrating an example of a processing configuration (processing module) of the conference room terminal 10. Referring to FIG. 11, the conference room terminal 10 includes a communication control unit 301, a face image acquisition unit 302, a voice transmission unit 303, a conference ID transmission unit 304, a shared information output unit 305, and a storage unit 306.

The communication control unit 301 is a unit that controls communication with other devices. Specifically, the communication control unit 301 receives data (packet) from the server device 20. The communication control unit 301 transmits data to the server device 20. The communication control unit 301 delivers data received from another device to another processing module. The communication control unit 301 transmits data acquired from the another processing module to the another device. As described above, the another processing module transmits and receives data to and from the another device via the communication control unit 301.

The face image acquisition unit 302 is a unit that controls a camera device and acquires a face image (biological information) of a participant seated in front of the own device. The face image acquisition unit 302 images the front of the own device periodically or at a predetermined timing. The face image acquisition unit 302 determines whether a face image of a person is included in the acquired image, and extracts the face image from the acquired image data in a case where the face image is included. The face image acquisition unit 302 transmits a set including the extracted face image and the ID (conference room terminal ID; for example, an IP address) of the own device to the server device 20.

Since an existing technique can be used for a face image detection process or a face image extraction process by the face image acquisition unit 302, detailed description thereof will be omitted. For example, the face image acquisition unit 302 may extract a face image (face region) from image data by using a learning model learned by a convolutional neural network (CNN). Alternatively, the face image acquisition unit 302 may extract the face image by using a method such as template matching.

The voice transmission unit 303 is a unit that acquires a voice of a participant and transmits the acquired voice to the server device 20. The voice transmission unit 303 acquires an audio file related to voices collected by a microphone (for example, a pin microphone). For example, the voice transmission unit 303 acquires an audio file encoded in a format such as a WAV file (Waveform Audio File).

The voice transmission unit 303 analyzes the acquired audio file, and in a case where an audio section (a section other than silence; a statement of the participant) is included in the audio file, transmits the audio file including the audio section to the server device 20. In this case, the voice transmission unit 303 transmits the audio file and the ID (conference room terminal ID) of the own device to the server device 20.

Alternatively, the voice transmission unit 303 may attach the conference room terminal ID to the audio file acquired from the microphone and transmit the audio file to the server device 20 without any change. In this case, the audio file acquired by the server device 20 may be analyzed to extract the audio file including the voice.

The voice transmission unit 303 extracts an audio file (a non-silent audio file) including the statement of the participant by using the existing “voice detection technique”. For example, the voice transmission unit 303 detects a voice by using a voice parameter sequence or the like modeled by a hidden Markov model (HMM).

The conference ID transmission unit 304 is a unit that transmits a conference ID of a conference to be held to the server device 20. For example, the conference ID transmission unit 304 generates a GUI used for a participant to input the conference ID, and displays the GUI on a display or the like. The conference ID transmission unit 304 transmits the conference ID acquired via the GUI to the server device 20.

Alternatively, the conference ID transmission unit 304 generates a GUI used for a participant to input information for generating a conference ID, and displays the GUI on a display or the like. For example, the conference ID transmission unit 304 may generate a GUI for inputting the holding date and time of the conference and the conference room number, and may generate a conference room ID from the acquired information (the holding date and time and the conference room number).

One or more conference room terminals 10 among the terminals used by the participants may transmit a conference ID or information for generating the conference ID to the server device 20. In the example in FIG. 2, one of the conference room terminals 10-1 to 10-3, 10-6, and 10-7 may transmit the conference ID and the like to the server device 20.

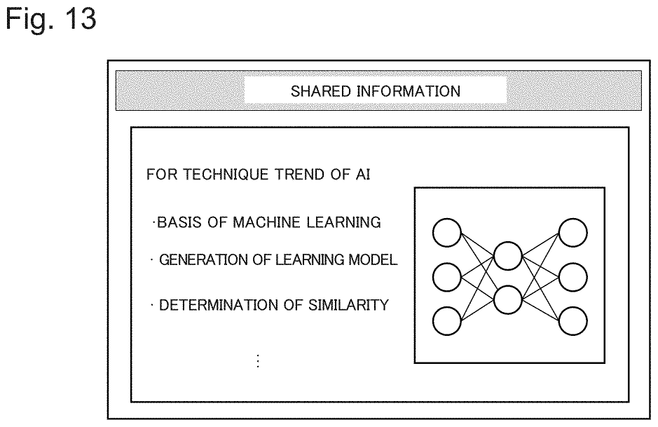

The shared information output unit 305 is a unit that outputs shared information. For example, the shared information output unit 305 displays the shared information acquired from the server device 20 on a display or the like. For example, the shared information output unit 305 displays a screen as illustrated in FIG. 13 on the display. The shared information output unit 305 may print the shared information, or may transmit the shared information to a predetermined e-mail address or the like.

The storage unit 306 is a unit that stores information necessary for an operation of the conference room terminal 10.

[Operation of Conference Assistance System]

Next, an operation of the conference assistance system according to the first example embodiment will be described.

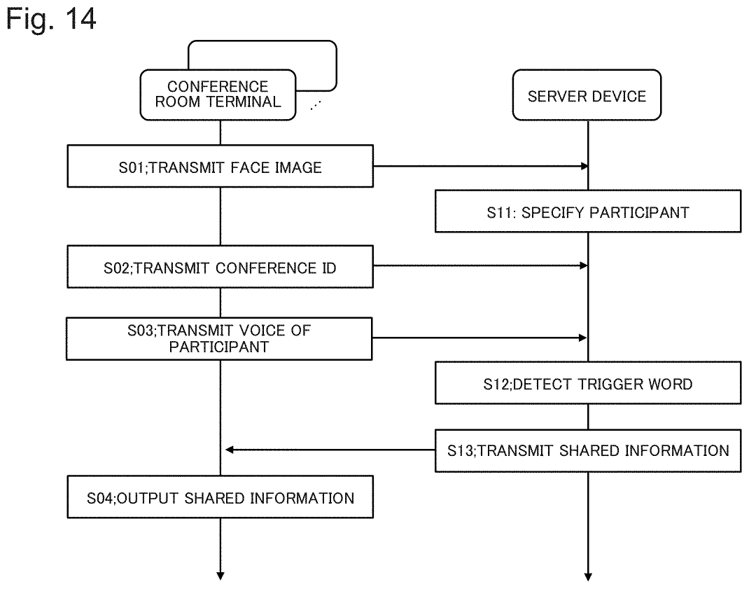

FIG. 14 is a sequence diagram illustrating an example of the operation of the conference assistance system according to the first example embodiment. FIG. 14 is a sequence diagram illustrating an example of a system operation when a conference is actually held. It is assumed that registration of a system user and input of conference prior information are performed in advance prior to the operation illustrated in FIG. 14.

When a participant is seated, the conference room terminal 10 acquires a face image of the seated participant and transmits the face image to the server device 20 (step S01).

The server device 20 specifies the participant by using the acquired face image (step S11). The server device 20 sets a feature amount calculated from the acquired face image as a feature amount on a collation side and sets the plurality of feature amounts registered in the user database as feature amounts on a registration side, and executes one-to-N(where N is a positive integer, and the same applies hereinafter) collation. The server device 20 repeats the collation for each participant (the conference room terminal 10 used by the participant) in the conference and generates a participant list.

At the start of the conference, the conference room terminal 10 transmits a conference ID to the server device 20 (step S02).

While the conference is in progress, the conference room terminal 10 acquires voices of the participant and transmits the voices to the server device 20 (step S03). That is, the voices of the participant are collected by the conference room terminal 10 and sequentially transmitted to the server device 20.

The server device 20 analyzes the acquired voice (audio file) and attempts to detect the trigger word from the statement of the participant (step S12).

When a trigger word is detected, the server device 20 transmits shared information (shared information output data) specified based on shared information specifying data to the conference room terminal 10 (step S13). In the above-described way, the server device 20 transmits the shared information to the conference room terminal 10 used by the participant in the conference.

The conference room terminal 10 outputs the acquired shared information (step S04).

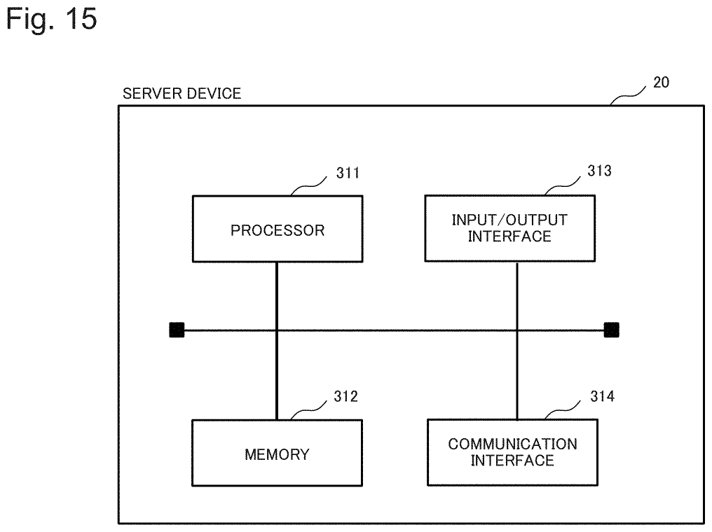

Next, hardware of each device configuring the conference assistance system will be described. FIG. 15 is a diagram illustrating an example of a hardware configuration of the server device 20.

The server device 20 may be configured by an information processing device (so-called computer), and has a configuration exemplified in FIG. 15. For example, the server device 20 includes a processor 311, a memory 312, an input/output interface 313, a communication interface 314, and the like. The constituents such as the processor 311 are connected to each other via an internal bus or the like, and are configured to be able to communicate with each other.

However, the configuration illustrated in FIG. 15 is not intended to limit a hardware configuration of the server device 20. The server device 20 may include hardware (not illustrated) or may not include the input/output interface 313 as necessary. The number of processors 311 and the like included in the server device 20 is not limited to the example in FIG. 15, and for example, a plurality of processors 311 may be included in the server device 20.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various data.

The input/output interface 313 is an interface of a display device or an input device (not illustrated). The display device is, for example, a liquid crystal display. The input device is a device such as a keyboard or a mouse that receives a user operation.

The communication interface 314 is a circuit, a module, or the like that communicates with another device. For example, the communication interface 314 includes a network interface card (NIC) or the like.

The functions of the server device 20 are achieved by various processing modules. The processing module is achieved, for example, by the processor 311 executing a program stored in the memory 312. The program may be recorded in a computer-readable storage medium. The storage medium may be a non-transient (non-transitory) medium such as a semiconductor memory, a hard disk, a magnetic recording medium, or an optical recording medium. That is, the present invention can also be embodied as a computer program product. The program may be downloaded via a network or updated by using a storage medium storing the program. The processing module may be achieved by a semiconductor chip.

The conference room terminal 10 can also be configured by an information processing device similarly to the server device 20, and since there is no difference in a basic hardware configuration from the server device 20, the description thereof will be omitted. The conference room terminal 10 may include a camera and a microphone, or may be configured to be connectable to a camera and a microphone.

As described above, the server device 20 according to the first example embodiment monitors a statement of a participant participating in a conference. The server device 20 attempts to detect a keyword (trigger word) previously registered by the participant from the statement of the participant. When the trigger word is detected, the server device 20 provides the participant in the conference with shared information registered together with the keyword. As a result, the shared information prepared in advance in conjunction with the statement of the participant is provided to other participants, and thus smooth information sharing in the conference is enabled.

### Modification Example

The configuration, operation, and the like of the conference assistance system described in the above example embodiment are merely examples, and are not intended to limit a configuration and the like of the system.

In the above example embodiment, in a case where a predetermined keyword (trigger word) is included in a statement of a participant, the server device 20 provides shared information to the participant. However, the server device 20 may provide a conference participant with shared information in a case where other conditions are satisfied. For example, the server device 20 may determine whether a statement of a participant in a conference is similar to a predetermined document, and provide shared information to the participant in the conference in a case where the statement of the participant is similar to the predetermined sentence. The server device 20 generates a “sentence vector” from the statement of the participant. The sentence vector is an index indicating how many times what kind of word has appeared in the statement (one sentence). At the time of registering the shared information, the participant registers a sentence serving as a trigger for providing the shared information to other participants. More specifically, the participant registers a “sentence vector” of a sentence serving as a trigger for calling the shared information. A “sentence vector” of a sentence serving as a trigger for calling the shared information will be described as a “trigger sentence vector”. The server device 20 calculates a similarity between the sentence vector generated from the statement of the participant and the trigger sentence vector, and provides the shared information to participants when the similarity is equal to or more than a predetermined value. For example, in a case where {AI, latest technique, important} are registered as the trigger sentence vector and a statement of the participant is “AI is an important technique”, three components of the trigger sentence vector are included in the statement of the participant. In this case, the server device 20 calculates “3” as the similarity. Alternatively, in a case where the statement of the participant is “AI is the latest important technique”, all the elements of the trigger sentence vector are included, and thus the server device 20 calculates a larger similarity, for example, the similarity “4”. As described above, the server device 20 may convert the statement of the participant into the sentence vector, and determine the shared information to be provided based on the similarity with a predetermined sentence vector (trigger sentence vector). The trigger sentence vector (a sentence serving as a trigger for providing the shared information) may be generated from the shared information. For example, the server device 20 may analyze a sentence of a web page in which the latest information to be provided to other participants is written and generate a trigger sentence vector.

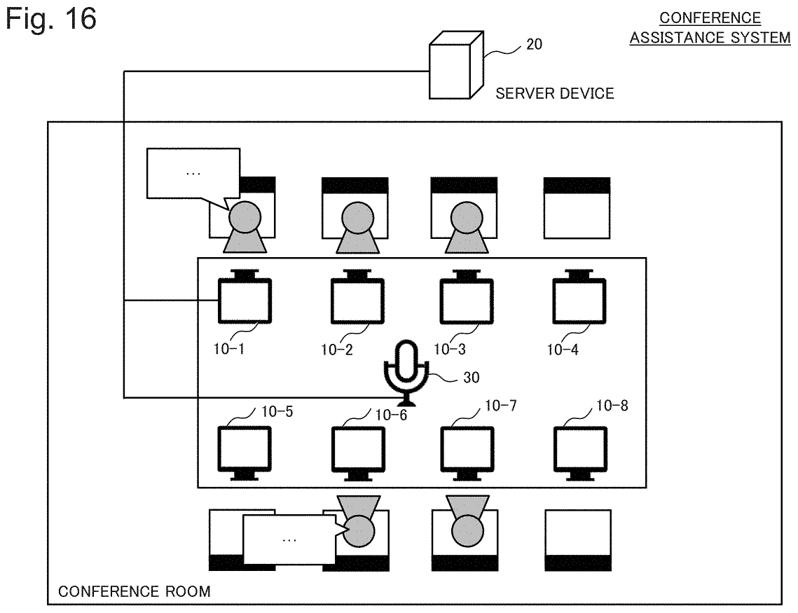

In the above example embodiment, a speaker in a conference is specified by generating a participant list. However, in order to enable display of shared information when a trigger word is detected, the speaker does not have to be specified. That is, as illustrated in FIG. 16, a single sound collecting microphone 30 may be installed on a desk, and the server device 20 may collect a statement of each participant via the sound collecting microphone 30. The server device 20 may transmit shared information to the conference room terminal 10 in a case where any of participants has uttered a trigger word.

Alternatively, information regarding speakers may be included in a condition for providing the shared information to the conference room terminal 10. For example, in a case where a participant A has uttered the trigger word, the shared information does not have to be provided to participants in the conference (the shared information does not have to be transmitted to the conference room terminal 10), and in a case where a participant B has uttered the trigger word, the shared information may be provided to the participants in the conference. In this case, the server device 20 may acquire the name or the like of a person (the participant B in the above example) as the condition for providing the shared information at the time of inputting the conference prior information illustrated in FIG. 8. When a user ID of a speaker of the trigger word matches a user ID registered in advance, the server device 20 transmits the shared information to the conference room terminal 10. With the above response, it is possible to prevent the shared information from being provided due to a statement of an unintended person.

When outputting the shared information, the conference room terminal 10 may also output information regarding a registrant of the shared information. For example, when performing the display illustrated in FIG. 13, the conference room terminal 10 may also display the name (profile) and the like of a user who has registered the shared information. In this case, the server device 20 notifies the conference room terminal 10 of the name and the like of the registrant together with the shared information.

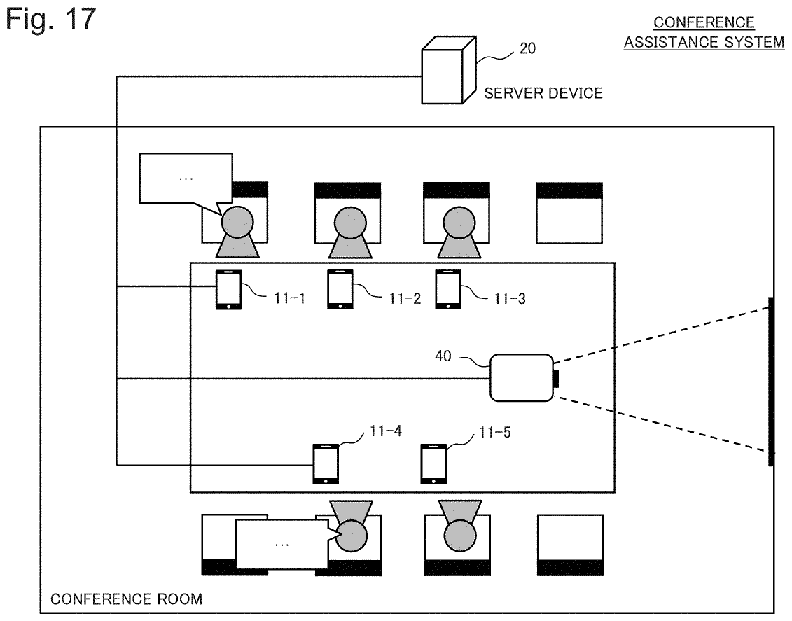

In the above example embodiment, the case where the dedicated conference room terminal 10 is installed on the desk has been described, but the function of the conference room terminal 10 may be achieved by a terminal possessed (owned) by the participant. For example, as shown in FIG. 17, respective participants may participate in the conference by using terminals 11-1 to 11-5. The participant operates his/her terminal 11 and transmits his/her face image to the server device 20 at the start of the conference. The terminal 11 transmits a voice of the participant to the server device 20. The server device 20 may provide an image, a video, or the like to the participant by using a projector 40.

A profile of a system user (an attribute value of the user) may be input by using a scanner or the like. For example, the user inputs an image related to his/her business card to the server device 20 by using a scanner. The server device 20 executes an optical character recognition (OCR) process on the acquired image. The server device 20 may determine a profile of the user based on the obtained information.

In the above example embodiment, the case where biological information related to a “face image” is transmitted from the conference room terminal 10 to the server device 20 has been described. However, biological information related to “a feature amount generated from the face image” may be transmitted from the conference room terminal 10 to the server device 20. The server device 20 may execute a collation process with a feature amount registered in the user database by using the acquired feature amount (feature vector).

In the above example embodiment, the case where a participant registers shared information specifying data such as a web page before a conference has been described, but the shared information specifying data may be searched for by using an existing search engine or the like at the time of extracting a trigger word. As described above, shared information is not limited to information registered in advance in the system by a participant, and information generated or the like by the server device 20 may be used. That is, the server device 20 may automatically search for a trigger word and provide the search result as shared information without further processing, or may process and provide (distribute) the result.

In the flow chart (the flowchart and the sequence diagram) used in the above description, a plurality of steps (processes) are described in order, but an execution order of the steps executed in the example embodiment is not limited to the described order. In the example embodiment, for example, the order of the illustrated steps can be changed within a range in which there is no problem in terms of content, such as executing a plurality of processes in parallel.

The above example embodiments have been described in detail for better understanding of the present disclosure, and it is not intended that all the configurations described above are necessary. In a case where a plurality of example embodiments have been described, each example embodiment may be used alone or in combination. For example, a part of the configuration of the example embodiment may be replaced with a configuration of another example embodiment, or the configuration of another example embodiment may be added to the configuration of the example embodiment. Addition, deletion, and replacement of other configurations may occur for a part of the configuration of the example embodiment.

Although the industrial applicability of the present invention is apparent from the above description, the present invention can be suitably applied to a system or the like that assists a conference or the like held by a company or the like.

The whole or part of the example embodiments disclosed above can be described as, but not limited to, the following supplementary notes.

### [Supplementary Note 1]

A server device including:

a determination unit that analyzes a statement of a participant in a conference and determines whether the statement of the participant matches a predetermined condition; and

an information provision unit that provides predetermined shared information to the participant in the conference in a case where the statement of the participant matches the predetermined condition.

### [Supplementary Note 2]

The server device according to Supplementary Note 1, in which the determination unit determines whether a predetermined trigger word is included in the statement of the participant in the conference, and the information sharing unit provides shared information associated to the trigger word to the participant in the conference in a case where the trigger word is included in the statement of the participant.

### [Supplementary Note 3]

The server device according to Supplementary Note 2, further including: an acquisition unit that acquires conference prior information including information regarding the shared information before the conference is held.

### [Supplementary Note 4]

The server device according to Supplementary Note 3, in which the conference prior information includes information for generating a conference ID for specifying the conference,

the acquisition unit generates the conference ID by using the information for generating the conference ID, and

the information provision unit provides the shared information to the participant in the conference associated to the conference ID.

### [Supplementary Note 5]

The server device according to Supplementary Note 3 or 4, in which

the conference prior information includes the trigger word and shared information specifying data for specifying the shared information, and

the information provision unit provides the shared information specified based on the shared information specifying data to the participant in the conference.

### [Supplementary Note 6]

The server device according to Supplementary Note 1, in which

the determination unit determines whether the statement of the participant in the conference is similar to a predetermined document, and

the information sharing unit provides shared information associated to the predetermined sentence to the participant in the conference in a case where the statement of the participant is similar to the predetermined sentence.

### [Supplementary Note 7]

The server device according to any one of Supplementary Notes 3 to 6, in which the information provision unit transmits the shared information to a terminal used by the participant in the conference.

### [Supplementary Note 8]

The server device according to Supplementary Note 7, further including:

a user database that stores an ID of a user and biological information of the user in association with each other; and

a participant specifying unit that performs collation between biological information transmitted from the terminal and the biological information registered in the user database and specifies the participant in the conference.

### [Supplementary Note 9]

The server device according to any one of Supplementary Notes 2 to 8, in which the information provision unit notifies the participant in the conference of information regarding a user who has registered the conference prior information.

### [Supplementary Note 10]

The server device according to Supplementary Note 5, in which the shared information specifying data is a uniform resource locator (URL) of a web page in which the shared information is written.

### [Supplementary Note 11]

The server device according to Supplementary Note 5, in which the shared information specifying data is a path of a storage folder of a file including the shared information.

### [Supplementary Note 12]

A conference assistance system including:

a terminal; and

a server device, in which

the server device includes

a determination unit that analyzes a statement of a participant in a conference and determines whether the statement of the participant matches a predetermined condition; and

an information provision unit that provides predetermined shared information to the participant in the conference in a case where the statement of the participant matches the predetermined condition.

### [Supplementary Note 13]

A conference assistance method including:

by a server device,

analyzing a statement of a participant in a conference and determining whether the statement of the participant matches a predetermined condition; and

providing predetermined shared information to the participant in the conference in a case where the statement of the participant matches the predetermined condition.

### [Supplementary Note 14]

A computer readable storage medium storing a program causing a computer mounted on a server device to execute:

a process of analyzing a statement of a participant in a conference and determining whether the statement of the participant matches a predetermined condition; and

a process of providing predetermined shared information to the participant in the conference in a case where the statement of the participant matches the predetermined condition.

The forms of the Supplementary Notes 12 to 14 can be expanded to the forms of the Supplementary Notes 2 to 11, similarly to the form of the Supplementary Note 1.

The disclosures of the above citation list are incorporated herein by reference. Although the example embodiments of the present invention have been described above, the present invention is not limited to these example embodiments. It will be understood by those skilled in the art that these example embodiments are exemplary only and that various variations are possible without departing from the scope and spirit of the invention. That is, it goes without saying that the present invention includes various modifications and alterations that can be made by those skilled in the art in accordance with the entire disclosure including the claims and the technical idea.

### REFERENCE SIGNS LIST

10, 10-1 to 10-8 conference room terminal
11, 11-1 to 11-5 terminal
20, 100 server device
30 sound collecting microphone
40 projector
101 determination unit
102 information provision unit
201, 301 communication control unit
202 user registration unit
203 conference prior information acquisition unit
204 participant specifying unit
205 keyword detection unit
206 shared information provision unit
207, 306 storage unit
211 user information acquisition unit
212 ID generation unit
213 feature amount generation unit
214 entry management unit
221 voice acquisition unit
222 text conversion unit
223 trigger word determination unit
302 face image acquisition unit
303 voice transmission unit
304 conference ID transmission unit
305 shared information output unit
311 processor
312 memory
313 input/output interface
314 communication interface

What is claimed is:

1. A server device comprising:
a memory; and
at least one processor coupled to the memory
the at least one processor performing operations to:
analyze a statement of a participant in a conference and determine whether the statement of the participant matches a predetermined condition; and
provide predetermined shared information to the participant in the conference in a case where the statement of the participant matches the predetermined condition.

2. The server device according to claim 1, wherein the at least one processor further performs operation to:
determine whether a predetermined trigger word is included in the statement of the participant in the conference, and
provide shared information associated to the trigger word to the participant in the conference in a case where the trigger word is included in the statement of the participant.

3. The server device according to claim 2, wherein the at least one processor further performs operation to:
acquire conference prior information including information regarding the shared information before the conference is held.

4. The server device according to claim 3, wherein
the conference prior information includes information for generating a conference ID for specifying the conference, and
the at least one processor further performs operation to:
generate the conference ID by using the information for generating the conference ID, and
provide the shared information to the participant in the conference associated to the conference ID.

5. The server device according to claim 1, wherein
the conference prior information includes the trigger word and shared information specifying data for specifying the shared information, and
the at least one processor further performs operation to:
provide the shared information specified based on the shared information specifying data to the participant in the conference.

6. The server device according to claim 1, wherein the at least one processor further performs operation to:
determine whether the statement of the participant in the conference is similar to a predetermined sentence, and
provide shared information associated to the predetermined sentence to the participant in the conference in a case where the statement of the participant is similar to the predetermined sentence.

7. The server device according to claim 3, wherein the at least one processor further performs operation to:
transmit the shared information to a terminal used by the participant in the conference.

8. The server device according to claim 7, further comprising:
a user database that stores an ID of a user and biological information of the user in association with each other;
wherein the at least one processor further performs operation to:
perform collation between biological information transmitted from the terminal and biological information registered in the user database and specify the participant in the conference.

9. The server device according to claim 3, wherein the at least one processor further performs operation to:
notify a participant in the conference of information regarding a user who has registered the conference prior information.

10. The server device according to claim 5, wherein the shared information specifying data is a uniform resource locator (URL) of a web page in which the shared information is written.

11. The server device according to claim 5, wherein the shared information specifying data is a path of a storage folder of a file including the shared information.

12. (canceled)

13. A conference assistance method comprising:
by a server device,
analyzing a statement of a participant in a conference and determining whether the statement of the participant matches a predetermined condition; and
providing predetermined shared information to the participant in the conference in a case where the statement of the participant matches the predetermined condition.

14. A non-transitory computer readable storage medium storing a program causing a computer mounted on a server device to execute:
analyzing a statement of a participant in a conference and determining whether the statement of the participant matches a predetermined condition; and
providing predetermined shared information to the participant in the conference in a case where the statement of the participant matches the predetermined condition.
